(19) United States
(12) Patent Application Publication
(10) Pub. No.: US 2023/0127102 A1
(43) Pub. Date: Apr. 27, 2023

(54) CONTAINER-BASED GAME AND A METHOD OF MAKING THE SAME

(71) Applicant: Pete Sommerfeldt, Baltimore, MD (US)

(72) Inventor: Pete Sommerfeldt, Baltimore, MD (US)

(21) Appl. No.: 17/661,082

(22) Filed: Apr. 28, 2022

Related U.S. Application Data
(60) Provisional application No. 63/262,915, filed on Oct. 22, 2021.

(51) Int. Cl. A63B 67/00; A63B 63/08; A63B 67/06

(52) U.S. Cl. CPC A63B 67/002; A63B 63/08; A63B 67/06

(57) ABSTRACT

A container-based game and a method of making the same is provided. The game includes a container with a lid, wherein the lid has a hole. A net protrudes beyond the periphery of the lid. The objective of the game is bouncing an object off the lid, thereby missing the hole, so that the object is caught in the net. A method of making the present invention includes the step of forming a hole in a lid to a fishing bucket, then attaching, by way of an attachment point, a fishing net to a periphery of the opening or lid of the fishing bucket so that the fishing net extends away from the hole in the lid.

### CROSS-REFERENCE TO RELATED APPLICATION

This application claims the benefit of priority of U.S. provisional application No. 63/262,915 U.S. provisional application number filed 22 Oct. 2021, the contents of which are herein incorporated by reference.

### BACKGROUND OF THE INVENTION

The present invention relates to games of skill that incorporate a target for an object and, more particularly, a container-based game and a method of making the same. The container-based game incorporates the container's lid, which has a centrally disposed hole and a net protruding beyond the periphery of the lid. The net is targeted by a user, who is attempting to secure one or more balls in the net by way of first bouncing the ball off the lid. Netting one or more balls (i.e., thereby avoiding the ball passing through the lid's central hole) is how a player wins at the game embodied in the present invention.

The prior art is replete with games of skill involving shooting an object such as bean bags, washers, coins, balls, horseshoes, pucks, and other objects at a target. There are also games where players take turns tossing or bouncing ping pong balls across the length of a table into cups. All these games, however, are bulky, cumbersome, and are thus a handful to carry and transport when desired to be used or be stored. Moreover, these games generally take up too much space and so cannot fit in a small storage space. Furthermore, the paraphernalia for such games have no utility outside the game environment and do not have a handle with which a user can tote the entirety of the components easily from spot to spot.

In short, people look for games that are easy to store and carry around and, advantageously, have a utility when not being used as a game. Disadvantageously, current ball tossing games are cumbersome, bulky, and are a one-trick pony.

As can be seen, there is a need for a game of skill that is container-based, wherein the container has a utility outside the context of the game. As a corollary, the game of the present invention contemplates a method of making a game from a container, wherein the container is still functional according to its original utility when not being employed for game play. The container may be a fishing bucket, wherein the container's lid is provided with a centrally disposed hole, which still allows the bucket to be used for fishing. A net may be connected to the lid and/or the container to protrude beyond the periphery of a trailing edge the lid. As a result, an object travelling from a leading edge of the lid, opposite its trailing edge, may be bounced off an upper surface of the lid to be secured in the net, thereby scoring a game point. The game contemplates a user positioned so that the trailing edge is between them and the net, wherein the user needs to bounce the object off the upper surface of the lid prior to catching the object in the net, whereby the object avoids going through the central hole of the lid and into the container.

Furthermore, the net is dimensioned and adapted to fit (along with a plurality of objects) into the container when not in use, and the container has a handle for facilitating easy transport of the entirety of the game. The game embodied by the present invention is colloquially known as “FISHMOPONG” (as a fisherman's bucket was the inspiration for the game). FISHMOPONG may incorporate a lightweight five-gallon bucket with a lid and a handle, as well as a net (in certain embodiments, a small fishing net) and a bounceable ball, such as a ping pong ball.

Unlike the game of corn hole, this easily transportable game is fun for all ages, fits in a small storage space, and can be used for fishing when not being used as a game.

### SUMMARY OF THE INVENTION

In one aspect of the present invention, a container-based game apparatus includes a container having an opening communicating to an enclosure; a lid covering the opening, wherein the lid has a void, wherein the void is defined by a straight-line segment that passes through a center of the void, wherein the straight-line segment is approximately three inches in length; and a net connected to a periphery of the lid or the opening, wherein the net extends away from the void.

In another aspect of the present invention, the container-based game apparatus, further includes a handle operatively associated with the container; an object selected to be bounceable off an upper surface of the lid, wherein the container is a five-gallon bucket; and an attachment point that interconnects the net and said periphery, and wherein the attachment point is pivotable relative to said periphery, wherein the attachment point has a bend between a lid portion and a rim portion, wherein the lid and rim portions are vertical offset by at least a quarter of an inch; and a frame that defines a net opening of the net, and wherein the frame connects to the attachment point, wherein the attachment point is pivotable by way of a plastic deformation or through elastic deformation.

In yet another aspect of the present invention, a method of making a container-based game from fishing equipment, the method including the following: forming a void in a lid of a fishing bucket; attaching a fishing net to a periphery of the lid so that the fishing net extends away from the void; and providing balls that are bounceable off an upper surface of the lid and that are dimension to pass through the void, whereby the fishing bucket and the fishing net are usable as fishing equipment after playing the container-based game.

These and other features, aspects and advantages of the present invention will become better understood with reference to the following drawings, description and claims.

### BRIEF DESCRIPTION OF THE DRAWINGS

FIG. 1 is a perspective view of an exemplary embodiment of the present invention, shown in use.

FIG. 2 is an exploded perspective view of an exemplary embodiment of the present invention.

FIG. 3 is a section view of an exemplary embodiment of the present invention, taken along line 3-3 in FIG. 1.

FIG. 4 is a flow chart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a container-based game and a method of making the same. The game includes a container with a lid, wherein the lid has a centrally disposed hole and wherein a net protrudes beyond the periphery of the lid. The objective of the game is bouncing an object off the lid, thereby missing the hole, and into the net. Netting the object, while avoiding the object passing through the lid's central hole, is how a player wins at the game embodied in the present invention. A method of making the present invention includes the step of forming a hole in a lid to a fishing bucket, then attaching, by way of an attachment point, a fishing net to a periphery of the opening of the fishing bucket so that the fishing net extends away from the hole in the lid after the lid is attached along the periphery of the opening.

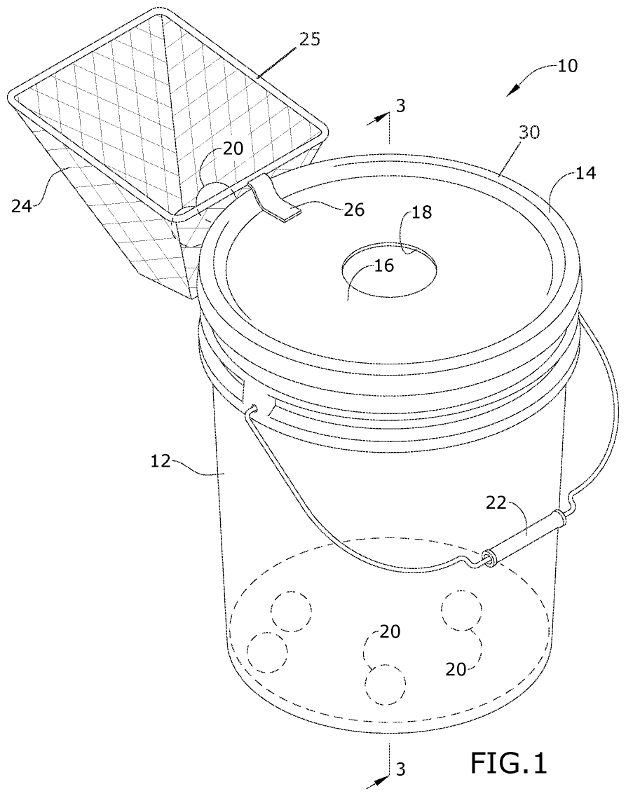

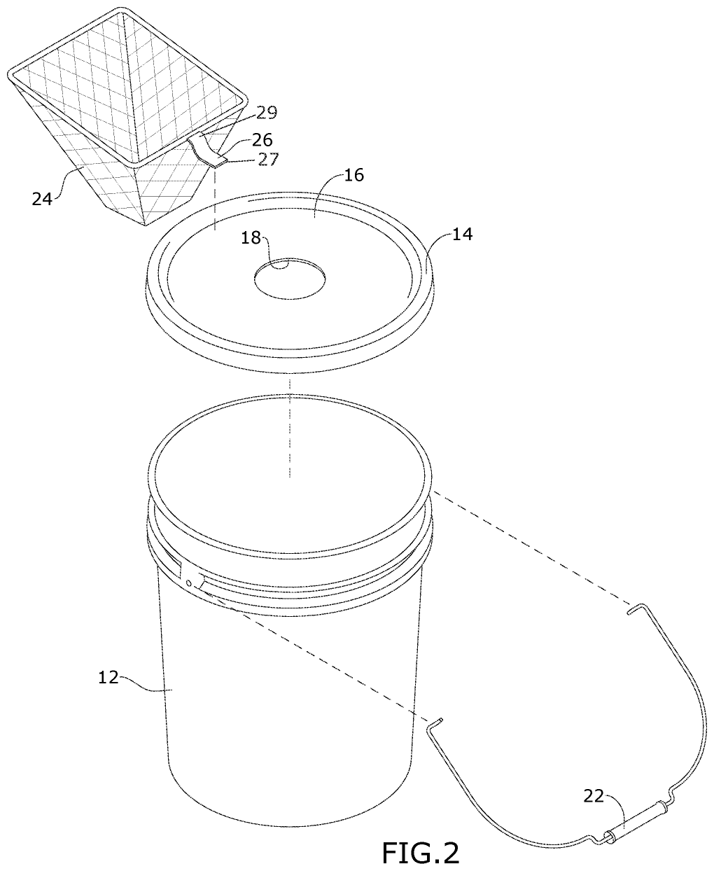

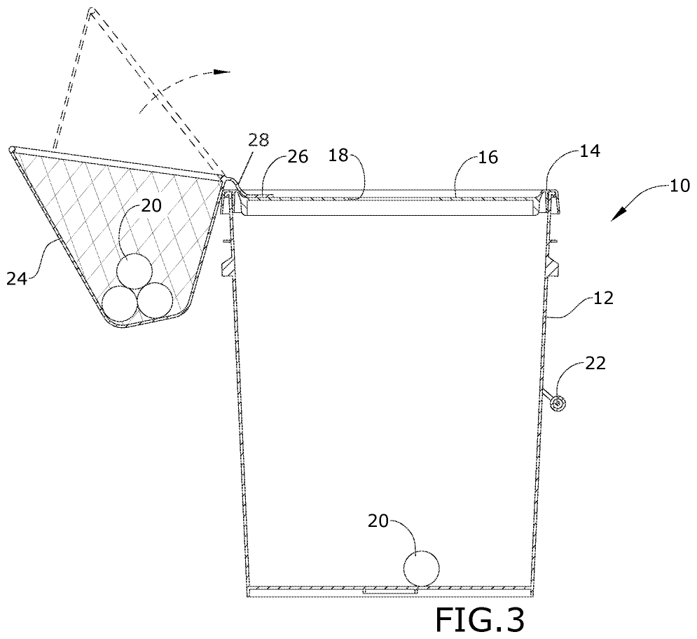

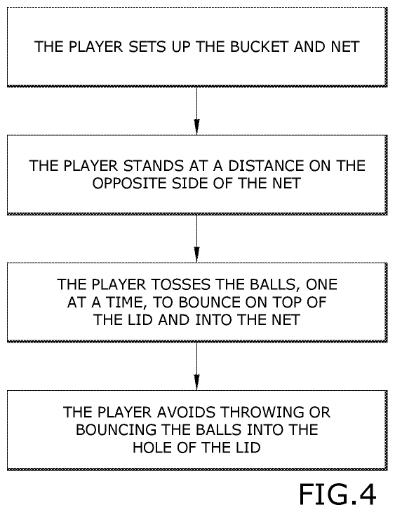

Referring now to FIGS. 1 through 4, the present invention may include a container-based game apparatus 10 having a bucket 12 and a lid 14 dimensioned and adapted to close off the opening of the container 12. A hole 18 may be provided in the lid 14. The hole 18 may be centrally disposed or could be located along different portions of the lid 14. In certain embodiments, the hole 18 may be off center from the upper surface 16 of the lid 14. In some embodiments of the present invention, there may be a plurality of holes 18. The hole 18 may be at least greater than the size of the object 20 the game is played with. In certain embodiments, the hole 18 is approximately three inches in diameter. The bucket 12 has a handle 22. The container 12 may be a five-gallon bucket, but it is understood that containers of other volumes may be used.

A net 24 may be connected to the lid 14 and/or the periphery of the opening of the container 12 so that the net 24 extends beyond a trailing edge of the periphery of the lid 14 or the container opening. The net 24 may have an attachment point 26, such as a handle portion, tab, or the like. The attachment point 26 may attach to the trailing edge. The opening of the net 24 may be defined by a frame 25. The frame 25 may be directly connected to the attachment point 26.

The attachment point 26 may have a bend 28 that interconnects a lid portion 27 and a rim portion 29 of the attachment point 26. The lid portion 27 is engageable to the lid 14 and the rim portion 29 is engageable to the rim 30 of the container 12 (or a portion of the lid 14 that engages the rim 30 of the container 12). The lid portion 27 and the rim portion 29 may be spaced apart by a distance approximately equal to a distance between an upper surface 16 of the lid 14 and an upper-most portion of the rim 30 of the container 12. The engagement may be through adhesive, bonding agents, removable fasteners or the like.

The attachment point 26 may enable the net 24 to be pivoted relative to the upper surface 16 of the lid 14. The attachment point 26 may also be adapted to retain desired positions (e.g., through selection of its material type, such as shape-memory polymers or similar semi-elastic or metallic materials that can be repeated bent without failing, of otherwise exhibits plastic deformation), thereby enabling a user to selectively (a) position the opening to the net 24 at, above, or below the rim 30 of the container 12, (b) adjust the angle of incidence of the opening of the net 24 relative to the upper surface 16 (from parallel, or a zero-degree angle of incidence to a ninety-degree angle of incidence where the opening is vertically oriented), or (c) assist in the removal the objects 20 from the net 24. In other embodiments, the attachment point is elastic and returns to its initial shape and size after removal of the force the urges the pivotable movement.

The net 24 may be elevated above, at, or below the elevation of the lid 14, which will be facilitated by the pivotability of the bend 28. The opening of the net 24 may be any size that is at least greater than the size of the object 20, and, in most but not all embodiments, have an upper opening less than the surface area of the lid 20. The upper surface 16 may have a diameter of between ten and fourteen inches. The net 24 may be a fishing net. The object 20 may be a ping-pong ball or other bounceable object.

The present invention may include one or more inserts inside the container 12, wherein each insert (not shown) functions as a “ball return” so that objects 20 that pass through the hole 18 are guided to a smaller opening along the bottom of the container 12.

A method of making the present invention may include the following. Provided with a five-gallon bucket 12 the manufacturer may form the hole 18 through the lid 14 of the bucket 12. The manufacturer may attach the net 24, by way of the attachment point 26, to the rim 30 of the container 12.

A method of using the present invention may include the following. The container-based game apparatus 10 disclosed above may be provided. A user may stand away from the container-based game apparatus 10, on a side thereof that is opposite of the net 24, i.e., the leading edge. Then the user attempts to bounce the object 20 off the upper surface 16 of the lid 14, avoiding the hole 18, so that the object 20 lands in the net 24.

Separately, the container 12 can be used to tote small items such as sunscreen, fishing equipment, bait, etc., when not being used as the container-based game apparatus 10, but rather for alternative useful purposes.

As used in this application, the term “about” or “approximately” refers to a range of values within plus or minus 10% of the specified number. Otherwise, the words “about,” “approximately,” or the like, when accompanying a numerical value, are to be construed as indicating a deviation as would be appreciated by one of ordinary skill in the art to operate satisfactorily for an intended purpose. And the term “substantially” refers to up to 90% more or less than that of an entirety.

Recitation of ranges of values herein are not intended to be limiting, referring instead individually to any and all values falling within the range, unless otherwise indicated, and each separate value within such a range is incorporated into the specification as if it were individually recited herein. Ranges of values and/or numeric values are provided herein as examples only, and do not constitute a limitation on the scope of the described embodiments.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A container-based game apparatus comprising:
a container having an opening communicating to an enclosure;
a lid covering the opening, wherein the lid has a void, wherein the void is defined by a straight-line segment that passes through a center of the void, wherein the straight-line segment is approximately three inches in length; and
a net connected to a periphery of the lid or the opening, wherein the net extends away from the void.

2. The container-based game apparatus of claim 1, further comprising a handle operatively associated with the container.

3. The container-based game apparatus of claim 2, further comprising an object selected to be bounceable off an upper surface of the lid.

4. The container-based game apparatus of claim 2, wherein the container is a five-gallon bucket.

5. The container-based game apparatus of claim 1, further comprising an attachment point that interconnects the net and said periphery, and wherein the attachment point is pivotable relative to said periphery.

6. The container-based game apparatus of claim 5, wherein the attachment point has a bend between a lid portion and a rim portion, wherein the lid and rim portions are vertical offset by at least a quarter of an inch.

7. The container-based game apparatus of claim 6, further comprising a frame that defines a net opening of the net, and wherein the frame connects to the attachment point.

8. The container-based game apparatus of claim 7, wherein the attachment point is pivotable by way of a plastic deformation.

9. The container-based game apparatus of claim 7, wherein the attachment point is pivotable through elastic deformation.

10. A method of making a container-based game from fishing equipment, the method comprising:
forming a void in a lid of a fishing bucket;
attaching a fishing net to a periphery of the lid so that the fishing net extends away from the void; and
providing balls that are bounceable off an upper surface of the lid and that are dimension to pass through the void,
whereby the fishing bucket and the fishing net are usable as fishing equipment after playing the container-based game.
